(19) United States
(12) Patent Application Publication
(10) Pub. No.: US 2015/0100579 A1
(43) Pub. Date: Apr. 9, 2015

(54) MANAGEMENT METHOD AND INFORMATION PROCESSING APPARATUS

(71) Applicant: FUJITSU LIMITED, Kawasaki-shi (JP)

(72) Inventors: Akio Oba, Kawasaki (JP); Yuji Wada, Ota (JP); Kuniaki Shimada, Kawasaki (JP)

(21) Appl. No.: 14/505,219

(22) Filed: Oct. 2, 2014

(30) Foreign Application Priority Data
Oct. 7, 2013 (JP) 2013-209889

(51) Int. Cl. G06F 17/30; G06N 5/04; H04L 29/08

(52) U.S. Cl. CPC G06F 17/30598; H04L 67/1097; G06N 5/04
USPC 707/737

(57) ABSTRACT

In an information processing apparatus for managing a system including apparatuses classified into clusters, an acquiring unit acquires history records from a memory unit based on scheduled change information indicating a scheduled change in configuration information of apparatuses accounting for a first rate amongst apparatuses belonging to a particular cluster. Each history record includes content related to a change in the configuration information of at least one or more apparatuses amongst apparatuses belonging to the same cluster. The acquiring unit acquires, from the memory unit, history records each associated with a change in the configuration information of apparatuses accounting for a second rate amongst apparatuses belonging to the same cluster. The second rate satisfies a predetermined similarity relationship with the first rate. A predicting unit predicts, based on the acquired history records, an impact on the system due to implementing the scheduled change.

### CROSS-REFERENCE TO RELATED APPLICATION

This application is based upon and claims the benefit of priority of the prior Japanese Patent Application No. 2013-209889, filed on Oct. 7, 2013, the entire contents of which are incorporated herein by reference.

### FIELD

The embodiments discussed herein are related to a management method and an information processing apparatus for managing a system including a plurality of apparatuses.

### BACKGROUND

A computer system is able to provide a wide range of services to users via a network. Thus, in the case of providing services via a network, it is important to be able to provide the services in a stable manner.

One of the factors that a system having been normally operating stops the normal operation is a configuration change of a parameter or the like set for computers in the system. For example, in the case of providing services by cloud computing, a large-scale information and communication technology (ICT) system is operated. A configuration change for each computer in the large-scale system could lead to a system failure. However, when the system includes a large number of computers, it is not easy to understand the magnitude of the failure occurrence risk due to the configuration change.

In view of this, there has been proposed a technology for enabling global changes in configuration parameters, amongst various groups of computers, only for computers belonging to a computer group designated by an administrator, and facilitating analysis of whether current configurations of computers conform to operational rules of a network system. This technology judges whether each management target computer uses configuration values inherited from its upper hierarchy, to thereby determine whether the configuration of the management target computer conforms to the operational rules.

Japanese Laid-open Patent Publication No. 2004-118371

In the case of implementing a configuration change of information, such as a parameter, knowing in advance the magnitude of an impact on the system due to the configuration change allows a precaution consistent with the magnitude of the impact to be taken. For example, if the configuration change has a low impact on the system and, thus, involves low risk of failure occurrence, only a short amount of time may be needed for operation checking after the configuration change. On the other hand, if the configuration change has a significant impact on the system and, thus, involves high risk of failure occurrence, such a countermeasure may be adopted that the configuration change is implemented during off-peak hours when few users are on the system, or that operational monitoring after the configuration change is carried out more closely than usual for an extended period of time.

However, simply judging whether configuration values inherited from the upper hierarchy are used gives no knowledge about the magnitude of the impact on the system due to the configuration change. This interferes with the establishment of an appropriate failure measurement corresponding to the magnitude of the impact on the system.

### SUMMARY

According to one embodiment, there is provided a non-transitory computer-readable storage medium storing a management program that is used in managing a system including a plurality of apparatuses classified into a plurality of clusters. The management program causes a computer to perform a procedure including acquiring, based on scheduled change information indicating a scheduled change in configuration information of apparatuses accounting for a first rate amongst apparatuses belonging to a particular one of the clusters, one or more history records each associated with a change in the configuration information of apparatuses accounting for a second rate amongst apparatuses belonging to one of the clusters from a memory storing history records each including content related to a change in the configuration information of at least one or more apparatuses amongst apparatuses belonging to one of the clusters, the second rate satisfying a predetermined similarity relationship with the first rate; and predicting, based on the acquired history records, an impact on the system due to implementing the scheduled change indicated by the scheduled change information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of an information processing apparatus according to a first embodiment;

FIG. 2 illustrates an example of a system configuration according to a second embodiment;

FIG. 3 illustrates an example of a hardware configuration of a management unit;

FIG. 4 is a block diagram illustrating functions of the management unit;

FIG. 5 illustrates an example of information stored in a configuration management database;

FIG. 6 illustrates an example of a data structure of tree information;

FIG. 7 illustrates an example of a data structure of a rule management table;

FIG. 8 illustrates an example of application of a rule ‘to be shared in a first hierarchical level’;

FIG. 9 illustrates an example of application of a rule ‘to be shared in a second hierarchical level’;

FIG. 10 illustrates an example of application of a rule ‘to be shared in a third hierarchical level’;

FIG. 11 illustrates an example of application of a rule ‘to be set for each server’;

FIG. 12 illustrates an example of a data structure of a failure history management database;

FIG. 13 is a flowchart illustrating an example of a procedure for predicting a degree of risk;

FIG. 14 is a flowchart illustrating an example of a procedure for calculating a degree of irregularity;

FIG. 15 illustrates differences in the degree of irregularity according to the number of rule-bound servers and the number of change target servers;

FIG. 16 illustrates an example of calculating the degree of irregularity in a case of rule-bound group entropy being 0;

FIG. 17 illustrates an example of calculating the degree of irregularity in a case of the rule-bound group entropy being 0.81;

FIG. 18 is a flowchart illustrating an example of a procedure for predicting a level of importance;

FIG. 19 illustrates a first example of extracting relative failure history records;

FIG. 20 illustrates a second example of extracting the relative failure history records;

FIG. 21 is a flowchart illustrating an example of a procedure for determining the degree of risk;

FIG. 22 illustrates an example of determination of the degree of risk; and

FIG. 23 illustrates an example of a screen transition from a screen for inputting scheduled change information to a screen for displaying the degree of risk.

### DESCRIPTION OF EMBODIMENTS

Several embodiments will be described below with reference to the accompanying drawings, wherein like reference numerals refer to like elements throughout. Note that two or more of the embodiments below may be combined for implementation in such a way that no contradiction arises.

### (a) First Embodiment

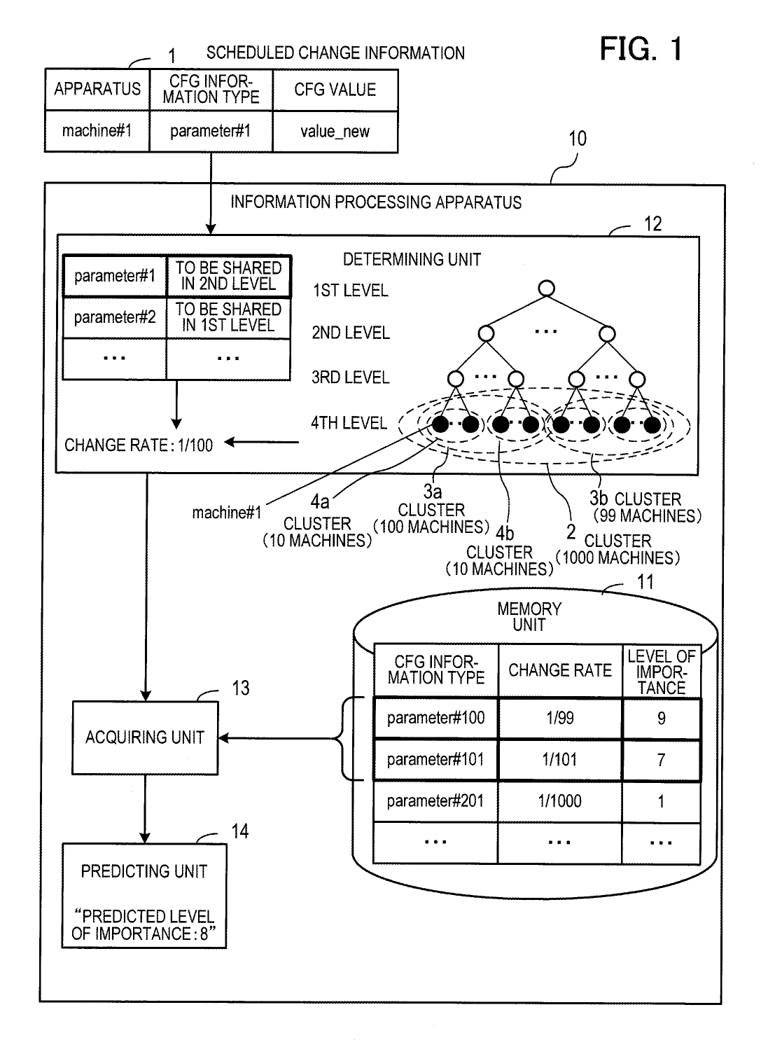

FIG. 1 illustrates an example of a functional configuration of an information processing apparatus according to a first embodiment. An information processing apparatus 10 includes a memory unit 11, a determining unit 12, an acquiring unit 13, and a predicting unit 14.

The memory unit 11 stores therein a plurality of history records, each of which includes content related to a change in configuration information of at least one or more apparatuses amongst apparatuses belonging to the same cluster. The content related to a change in configuration information may include the magnitude of an impact on a system due to the configuration information change. For example, each history record includes a configuration (CFG) information type, a change rate, and a level of importance. The configuration information type indicates a type of configuration information (for example, a configuration item name) the value of which was changed in target apparatuses. The change rate indicates the proportion of apparatuses, for which the change in the value of a corresponding configuration information type was implemented at the same time, to apparatuses belonging to a cluster prescribed by a rule to have a common value for the configuration information type. The level of importance is a numerical value indicating the magnitude of an impact on the system due to a corresponding configuration information change.

The determining unit 12 calculates a first rate using information serving as a basis for the calculation of the first rate when the information is included in scheduled change information 1 indicating a scheduled change in configuration information of apparatuses accounting for the first rate amongst apparatuses belonging to a particular cluster. The scheduled change information 1 designates, for example, at least one apparatus to undergo a configuration change, a configuration information type the value of which is to be changed, and a configuration value after the configuration change. Note that the first rate indicates, for example, the proportion of apparatuses, for which the change in the value of the configuration information type is to be implemented at the same time, to apparatuses belonging to a cluster prescribed by a rule to have a common value for the configuration information type.

The determining unit 12 manages a plurality of apparatuses in the system by organizing them into hierarchical clusters. The example of FIG. 1 illustrates a tree structure representing the relationship among hierarchical levels obtained when the apparatuses in the system are classified into clusters in four hierarchical levels. A lower hierarchical cluster in the tree structure is a subset of its upper hierarchical cluster. The first hierarchical level includes a single cluster 2 containing all the apparatuses in the system. The second hierarchical level includes a plurality of clusters 3a, 3b, and so on, each of which forms a subset of the cluster 2 in the first hierarchical level. The third hierarchical level includes a plurality of clusters 4a, 4b, and so on, each of which forms a subset of one of the clusters 3a, 3b, and so on in the second hierarchical level. The lowest, forth hierarchical level includes a plurality of clusters, each of which corresponds to a single apparatus and forms a subset of one of the clusters 4a, 4b, and so on in the third hierarchical level.

Further, the determining unit 12 holds, for each configuration information type, a rule defined for a hierarchical level in which apparatuses belonging to the same cluster share a common value for the configuration information type. For example, if a configuration information type is associated with a rule stating to share a common value within a cluster in the first hierarchical level, one common value is set for the configuration information type of apparatuses belonging to the cluster 2 in the first hierarchical level. Similarly, if a configuration information type is associated with a rule stating to share a common value within a cluster in the second hierarchical level, one common value is set for the configuration information type of apparatuses belonging to each of the clusters 3a, 3b, and so on in the second hierarchical level. Note that these rules are provided for the purpose of standardization and not compulsory. Therefore, it is allowed to configure settings deviated from the rules.

Upon an input of the scheduled change information 1, the determining unit 12 identifies, amongst clusters in a hierarchical level indicated by a rule applied to a configuration information type designated by the scheduled change information 1, a cluster to which at least one change target apparatus designated by the scheduled change information 1 belongs. Then, the determining unit 12 determines, as the first rate, the proportion of the change target apparatus to apparatuses belonging to the identified cluster. The determining unit 12 notifies the acquiring unit 13 of the determined first rate. Note that the first rate may be directly defined in the scheduled change information 1. In such a case, the scheduled change information 1 input to the information processing apparatus 10 is input to the acquiring unit 13 without involving the determining unit 12.

Based on the scheduled change information 1, the acquiring unit 13 acquires, from the memory unit 11, history records each associated with a change in configuration information of apparatuses accounting for a second rate amongst apparatuses belonging to the same cluster. Here, the second rate satisfies a predetermined similarity relationship with the first rate. For example, the acquiring unit 13 determines that the second rate satisfies the predetermined similarity relationship if the second rate falls within a predetermined range around the first rate.

In addition, the acquiring unit 13 may determine the similarity relationship after performing a predetermined calculation on the first rate or the second rate. For example, the acquiring unit 13 defines the reciprocal of the first or second rate as the degree of irregularity. The degree of irregularity of the first rate is an index related to the scheduled configuration change and indicating the degree of divergence within the cluster from the corresponding rule, obtained when the scheduled configuration change is carried out. Here, the degree of divergence is related to the rate of apparatuses diverging from the rule within the cluster in terms of the value of the configuration information type. The degree of irregularity of the second rate is an index related to a configuration change having led to the registration of a corresponding history record and indicating the degree of divergence within a cluster from a rule, obtained after the configuration change was carried out. For example, the acquiring unit 13 determines that the second rate satisfies the predetermined similarity relationship if the difference (or ratio) between the degree of irregularity of the first rate and that of the second rate falls within a predetermined range.

Further, the acquiring unit 13 may reflect, in the degree of irregularity, the degree of uniformity among values of the configuration information type of apparatuses belonging to the cluster just before the scheduled configuration change. For example, as for the configuration information of individual apparatuses belonging to a cluster including the change target apparatus, the acquiring unit 13 compares values of the same configuration information type (i.e., a configuration information type supposed to have a common value according to a rule) as that of the scheduled configuration change. Subsequently, the acquiring unit 13 calculates the degree of divergence from the rule, and uses the calculation result to determine whether the second rate satisfies the predetermined similarity relationship. The divergence from the rule is represented, for example, by the entropy. For example, the acquiring unit 13 uses, as the degree of irregularity, a value obtained by dividing the reciprocal of the first or second rate by ‘entropy+1’.

The acquiring unit 13 transmits, to the predicting unit 14, the history records acquired from the memory unit 11. Based on the acquired history records, the predicting unit 14 predicts the magnitude of an impact on the system due to the configuration information change indicated in the scheduled change information 1. For example, the predicting unit 14 is able to predict the magnitude of the impact based on the level of importance provided in each of the acquired history records. In the case of using the level of importance, the predicting unit 14 employs, for example, the average of the levels of importance provided in the acquired history records as the magnitude of the impact. Alternatively, the predicting unit 14 may reflect, in the prediction, more strongly the content of a history record whose second rate has a higher degree of similarity to the first rate. Further, the predicting unit 14 may calculate the deviation of a predicted level of importance based on the distribution of the levels of importance provided in the acquired history records and compare the deviation with predetermined threshold values, to thereby determine the level of risk of the scheduled configuration change.

According to the information processing apparatus 10 having the above-described functional configuration, upon an input of the scheduled change information 1, the determining unit 12 calculates the change rate. In the example of FIG. 1, the scheduled change information 1 indicates a change in the value of a configuration information type ‘parameter#1’ of an apparatus ‘machine#1’. Here, a rule ‘to be shared in the second hierarchical level’ is defined to be applied to the configuration information type ‘parameter#1’, and the apparatus ‘machine#1’ belongs to the cluster 3a among the clusters 3a, 3b, and so on in the second hierarchical level. Assume here that a hundred apparatuses belong to the cluster 3a. Because the scheduled change information designates one apparatus (i.e., machine#1) as the change target, the change rate is 1/100, which is determined as the first rate.

The acquiring unit 13 is notified of the determined first rate, and then extracts, from the memory unit 11, history records whose change rate satisfies a predetermined similarity relationship with the first rate 1/100. For example, if the reciprocal of a change rate falls within a range of plus or minus 10% of the reciprocal of the first rate, the change rate is determined to satisfy the similarity relationship with the first rate. In this case, a change rate is determined to satisfy the similarity relationship when the change rate falls within a range between 1/90 and 1/110. History records whose change rates have been recognized to satisfy the similarity relationship are extracted from the memory unit 11 and then transferred to the predicting unit 14.

Subsequently, the predicting unit 14 calculates the magnitude of an impact on the system, to be caused by implementing the configuration information change designated by the scheduled change information 1. For example, if the levels of importance of the extracted history records are 9 and 7, the average value of them, 8, may be used as the magnitude of the impact.

In the above-described manner, a user about to make the configuration change is able to understand the magnitude of the impact quantitatively. Understanding the magnitude of the impact allows a failure countermeasure to be adopted before the configuration change, or allows a change to be made in the period of time for operation checking after the configuration change, according to the magnitude of the impact. As a result, it is thus possible to prevent reducing system reliability associated with configuration changes.

Conventionally, if failure events due to implementation of changes in the same configuration information type as that of the scheduled configuration change have occurred previously, referring to history records of the failure events allows the magnitude of an impact to be determined. However, if there is no such a failure event to refer to, it is difficult to determine the magnitude of an impact caused by the scheduled configuration change.

On the other hand, according to the first embodiment, history records are extracted based on the rate of apparatuses to undergo a configuration change within a cluster, and therefore, it is possible to determine the magnitude of an impact caused by the configuration change, for example, even without history records of changes in the same configuration information type as that of the configuration change. Here is the reason why extraction of history records based on the rate of apparatuses to undergo a configuration change within a cluster is effective for the determination of the magnitude of an impact caused by the configuration change.

For example, in the case where a common value has been set for a particular configuration information type of apparatuses in a particular cluster according to a corresponding rule, some of the apparatuses diverge from the rule when the value of the configuration information type is changed in those apparatuses. If configuration changes causing the same degree of divergence from a rule took place in the past, history records of the past configuration changes serve as a useful reference to determine the magnitude of an impact to be caused. The degree of divergence from a rule after a configuration change is estimated by the rate of apparatuses to undergo the configuration change in a cluster. Therefore, in order to determine the magnitude of an impact to be caused by a scheduled configuration change, it is effective to extract history records of previous configuration changes, each satisfying a predetermined similarity relationship with the rate of apparatuses to undergo the scheduled configuration change in a cluster.

Note that the determining unit 12, the acquiring unit 13, and the predicting unit 14 may be implemented, for example, by a processor of the information processing apparatus 10. In addition, the memory unit 11 may be implemented, for example, by memory of the information processing apparatus 10. In FIG. 1, each line connecting the individual components represents a part of communication paths, and communication paths other than those illustrated in FIG. 1 are also configurable.

### (b) Second Embodiment

A second embodiment is described next. The second embodiment is directed to predicting the degree of risk of failure occurrence when a change is made in a value of configuration information (for example, a parameter) of apparatuses, such as servers, installed in a plurality of data centers.

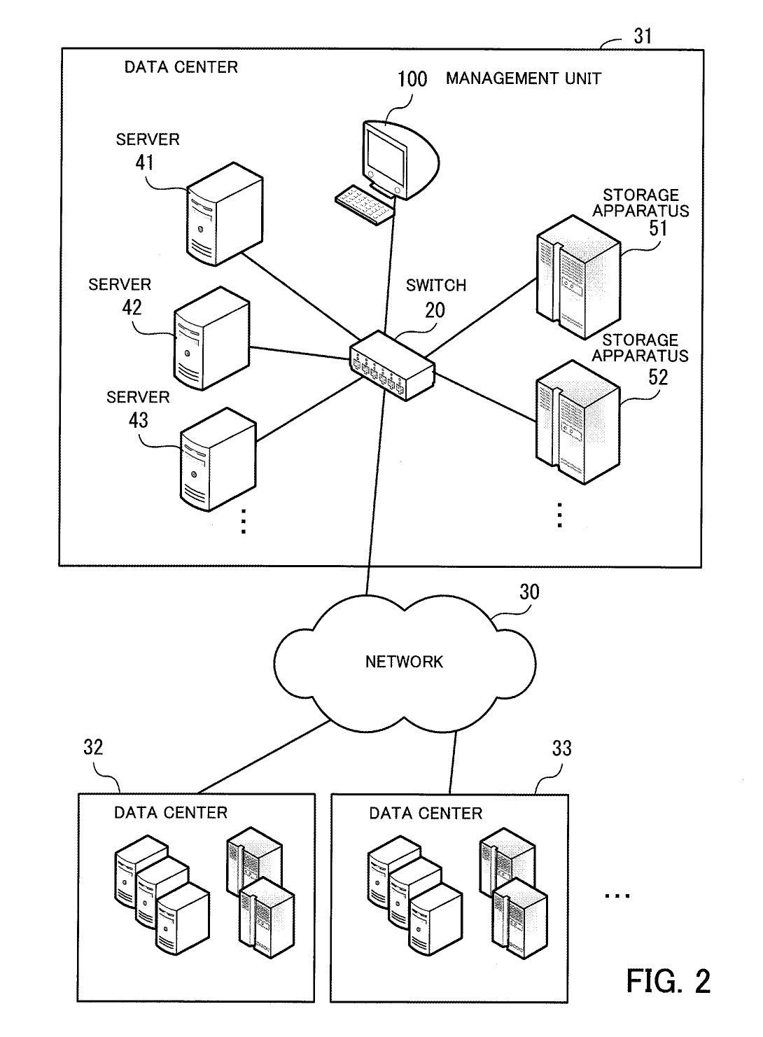

FIG. 2 illustrates an example of a system configuration according to the second embodiment. A plurality of data centers 31, 32, 33, and so on are connected to each other via a network 30. The data center is equipped with a plurality of servers 41, 42, 43, and so on and a plurality of storage apparatuses 51, 52, and so on. The servers 41, 42, 43, and so on and the storage apparatuses 51, 52, and so on are connected to each other via a switch 20. The remaining individual data centers 32, 33, and so on are also equipped with a plurality of servers and a plurality of storage apparatuses.

The data center 31 is further equipped with a management unit 100 for managing the operation of the entire system. For example, the management unit 100 accesses each apparatus in the individual data centers 31, 32, 33, and so on via the switch 20 to thereby configure the environment of the apparatus. The management unit 100 is capable of estimating the degree of risk of failure occurrence due to a change in a configuration information value in environment configuration prior to making the change. According to the degree of risk estimated by the management unit 100, an administrator of the system is able to modify a procedure for changing the configuration information value. For example, if the configuration change involves high risk, the administrator carries out the change of the configuration information value after implementing sufficient backup measures so as to avoid causing problems to the system operation. On the other hand, if the configuration change involves low risk, the administrator carries out the change of the configuration information value by an efficient procedure while continuing the system operation.

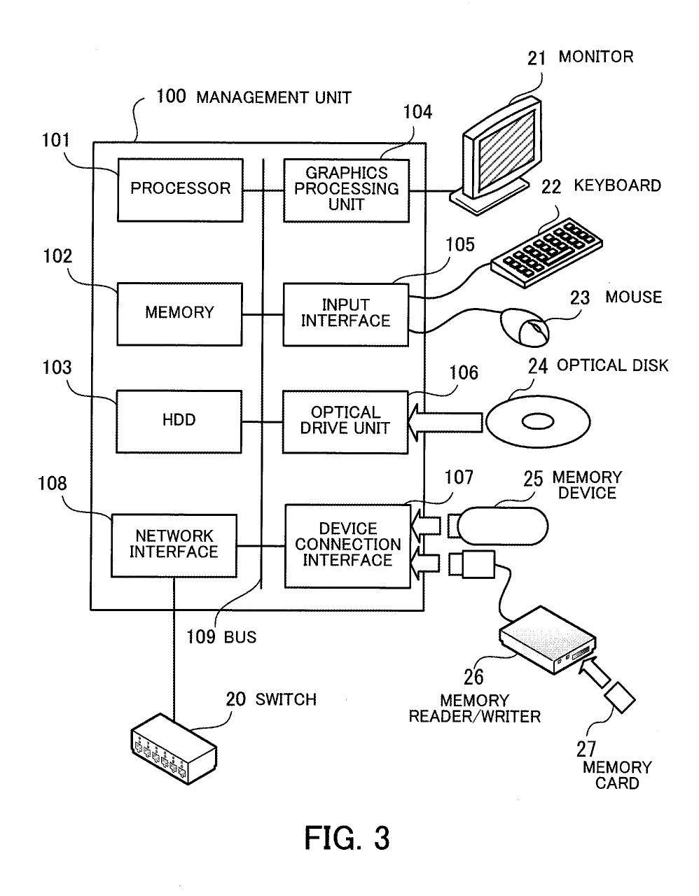

The above-described management unit 100 capable of predicting the degree of risk is implemented by a computer with a hardware configuration illustrated in FIG. 3. FIG. 3 illustrates an example of a hardware configuration of a management unit. Overall control of the management unit 100 is exercised by a processor 101. To the processor 101, memory 102 and a plurality of peripherals are connected via a bus 109. The processor 101 may be a multi-processor. The processor 101 is, for example, a central processing unit (CPU), a micro processing unit (MPU), or a digital signal processor (DSP). At least part of the functions of the processor 101 may be implemented as an electronic circuit, such as an application specific integrated circuit (ASIC) and a programmable logic device (PLD).

The memory 102 is used as a main storage device of the management unit 100. The memory 102 temporarily stores at least part of an operating system (OS) program and application programs to be executed by the processor 101. The memory 102 also stores therein various types of data to be used by the processor 101 for its processing. As the memory 102, a volatile semiconductor storage device such as a random access memory (RAM) may be used.

The peripherals connected to the bus 109 include a hard disk drive (HDD) 103, a graphics processing unit 104, an input interface 105, an optical drive unit 106, a device connection interface 107, and a network interface 108.

The HDD 103 magnetically writes and reads data to and from a built-in disk, and is used as a secondary storage device of the management unit 100. The HDD 103 stores therein the OS program, application programs, and various types of data. Note that a non-volatile semiconductor storage device such as a flash memory may be used as a secondary storage device in place of the HDD 103.

To the graphics processing unit 104, a monitor is connected. According to an instruction from the processor 101, the graphics processing unit 104 displays an image on a screen of the monitor 21. A cathode ray tube (CRT) display or a liquid crystal display, for example, may be used as the monitor 21.

To the input interface 105, a keyboard 22 and a mouse 23 are connected. The input interface 105 transmits signals sent from the keyboard 22 and the mouse 23 to the processor 101. Note that the mouse 23 is just an example of pointing devices, and a different pointing device such as a touch panel, a tablet, a touch-pad, and a track ball, may be used instead.

The optical drive unit 106 reads data recorded on an optical disk 24 using, for example, laser light. The optical disk 24 is a portable storage medium on which data is recorded in such a manner as to be read by reflection of light. Examples of the optical disk 24 include a digital versatile disc (DVD), a DVD-RAM, a compact disk read only memory (CD-ROM), a CD recordable (CD-R), and a CD-rewritable (CD-RW).

The device connection interface 107 is a communication interface for connecting peripherals to the management unit 100. To the device connection interface 107, for example, a memory device 25 and a memory reader/writer 26 may be connected. The memory device 25 is a storage medium having a function for communicating with the device connection interface 107. The memory reader/writer 26 is a device for writing and reading data to and from a memory card 27. The memory card 27 is a card type storage medium.

The network interface 108 is connected to the switch 20. Via the switch 20, the network interface 108 transmits and receives data to and from different computers and communication devices.

The hardware configuration described above achieves the processing functions of the second embodiment. Note that the information processing apparatus 10 of the first embodiment may be constructed with the same hardware configuration as the management unit 100 of FIG. 3. In addition, each server illustrated in FIG. 2 may also be constructed with the same hardware configuration as the management unit 100.

The management unit 100 achieves the processing functions of the second embodiment, for example, by implementing a program stored in a computer-readable storage medium. The program describing processing contents to be implemented by the management unit 100 may be stored in various types of storage media. For example, the program to be implemented by the management unit 100 may be stored in the HDD 103. The processor 101 loads at least part of the program stored in the HDD 103 into the memory 102 and then runs the program. In addition, the program to be implemented by the management unit 100 may be stored in a portable storage medium, such as the optical disk 24, the memory device 25, and the memory card 27. The program stored in the portable storage medium becomes executable after being installed on the HDD 103, for example, under the control of the processor 101. Alternatively, the processor 101 may run the program by directly reading it from the portable storage medium.

Under the control of the processor 101, the management unit 100 achieves a configuration change function for changing configuration information of apparatuses, such as servers, and a prediction function for predicting the degree of risk involved in a configuration change.

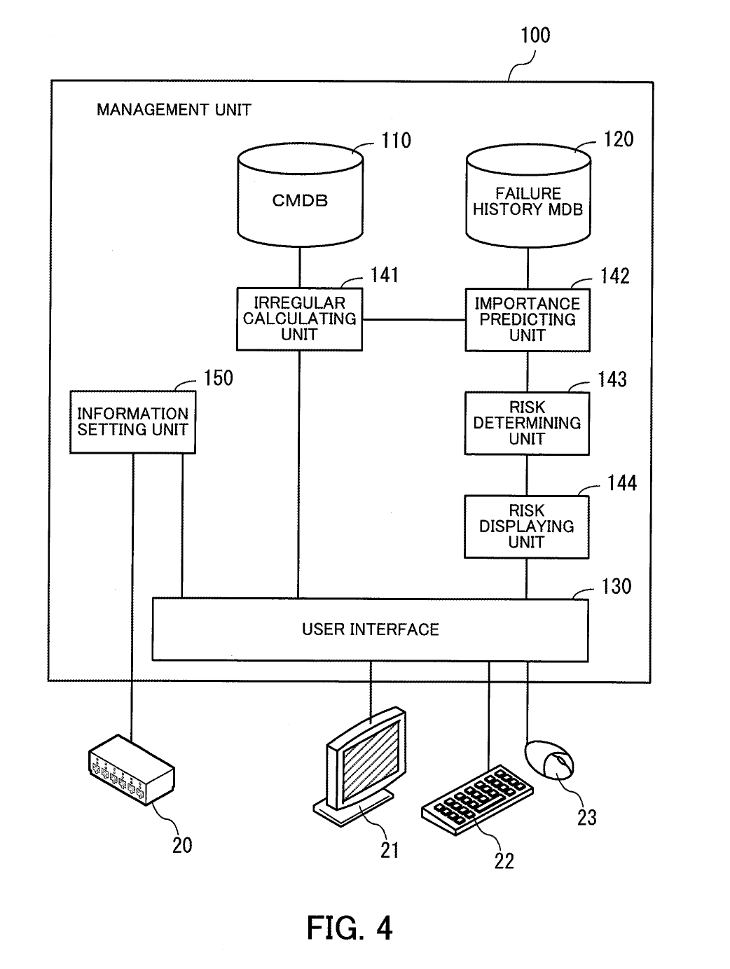

FIG. 4 is a block diagram illustrating functions of a management unit. The management unit 100 is provided in advance with a configuration management database (CMDB) 110 and a failure history management database 120 serving as information management functions and built, for example, in the HDD 103.

The configuration management database 110 manages information indicating the configuration of the system. For example, in the configuration management database 110, connection relations of apparatuses in the system are organized into a hierarchical tree structure. In addition, the configuration management database 110 stores therein rules indicating standard configuration regulations to be followed when setting values for configuration information (for example, parameters) to configure environments of apparatuses in the system. These rules are provided for the purpose of setting standardized configurations and it is therefore allowed to set configurations diverging from the rules. Note however that, in the case of setting a configuration diverging from the rules, the configuration may cause a failure to the system.

The failure history management database 120 manages history records of failures having previously occurred in the system. For example, the failure history management database 120 stores therein history records of failures (failure history records) caused by changes in environment configurations of apparatuses, such as servers. Each of the failure history records includes the level of importance of a corresponding failure. As for the level of importance, for example, a large value is assigned if a corresponding failure had a serious impact on the system, and a small value is assigned if a corresponding failure had a minor impact on the system. In addition, each failure history record associated with a failure due to a change in a configuration information value includes, for example, the degree of irregularity obtained when the configuration change was made. The degree of irregularity is an index indicating the degree of divergence from an applicable rule (i.e., what proportion of configuration values diverge from the rule).

The management unit 100 includes, as information processing functions, a user interface 130, an irregularity calculating unit 141, an importance predicting unit 142, a risk determining unit 143, a risk displaying unit 144, and an information setting unit 150.

The user interface 130 exchanges information with a user. The user interface 130 receives an input from an input device, such as the keyboard 22 or the mouse 23, and notifies a different unit of the input content. In the case of changing environment configurations of apparatuses, the user playing a role of an administrator inputs scheduled change information indicating configuration change content, using the keyboard 22 or the like. Then, the user interface 130 transmits the input scheduled change information to the irregularity calculating unit 141. Upon an input of change information indicating configuration change content to be applied, the user interface 130 transmits the change information to the information setting unit 150. Upon receiving a processing result from a different unit, the user interface 130 displays the processing result on the monitor 21. For example, when the user interface 130 is notified of the degree of risk involved in a configuration change by the risk displaying unit 144, the user interface 130 displays the degree of risk on the monitor 21.

Upon receiving the scheduled change information, the irregularity calculating unit 141 calculates the degree of irregularity by referring to the configuration management database 110. The degree of irregularity is a numerical value associated with the scheduled configuration change and representing the degree of divergence of changed configuration information from a corresponding standard configuration rule. The irregularity calculating unit 141 transmits the calculated degree of irregularity to the importance predicting unit 142.

The importance predicting unit 142 predicts, based on failure history records, the level of importance of a failure caused by implementing the scheduled configuration change. For example, the importance predicting unit 142 searches the failure history management database 120 for failure history records associated with the input scheduled change information (relevant failure history records). Then, based on the level of importance provided in each of the relevant failure history records, the importance predicting unit 142 predicts the level of importance of a failure caused by a configuration change designated by the scheduled change information. The relevant failure history records include, for example, failure history records whose degree of irregularity is similar to the degree of irregularity calculated based on the scheduled change information. In addition, the relevant failure history records may include failure history records associated with changes in the value of the same configuration information type as that of the scheduled change. The importance predicting unit 142, for example, extracts the relevant failure history records from the failure history management database 120, and employs the average of the levels of importance provided in the relevant failure history records as a predictive value of the level of importance (predictive level of importance). The importance predicting unit 142 notifies the risk determining unit 143 of the calculated predictive level of importance.

The risk determining unit 143 determines, based on the predictive level of importance, the degree of risk of failure occurrence due to applying the change content designated by the scheduled change information. For example, the risk determining unit 143 calculates the degree of risk using a calculation expression which produces a higher degree of risk when the levels of importance designated by the relevant failure history records are higher. The risk determining unit 143 notifies the risk displaying unit 144 of the calculated degree of risk. For example, the risk determining unit 143 has preliminarily classified the scale of risk into a plurality of risk levels, and then notifies the risk displaying unit 144 of a corresponding risk level.

The risk displaying unit 144 causes the user interface 130 to display, on the monitor 21, the degree of risk notified of by the risk determining unit 143. For example, the risk displaying unit 144 transmits, to the user interface 130, a request to display a screen presenting the risk level.

Upon receiving, via the user interface 130, an instruction to set information for an apparatus, such as a server, the information setting unit 150 accesses the setting target apparatus via the switch 20 to thereby set configuration information, such as a parameter.

In FIG. 4, each line connecting the individual components represents a part of communication paths, and communication paths other than those illustrated in FIG. 4 are also configurable. Each of the following functions of FIG. 4 is an example of a corresponding unit of the first embodiment of FIG. 1: the irregularity calculating unit 141 is an example of the determining unit 12; the importance predicting unit 142 is an example of an integrated function of the acquiring unit 13 and the predicting unit 14; and the risk determining unit 143 is an example of a partial function of the predicting unit 14.

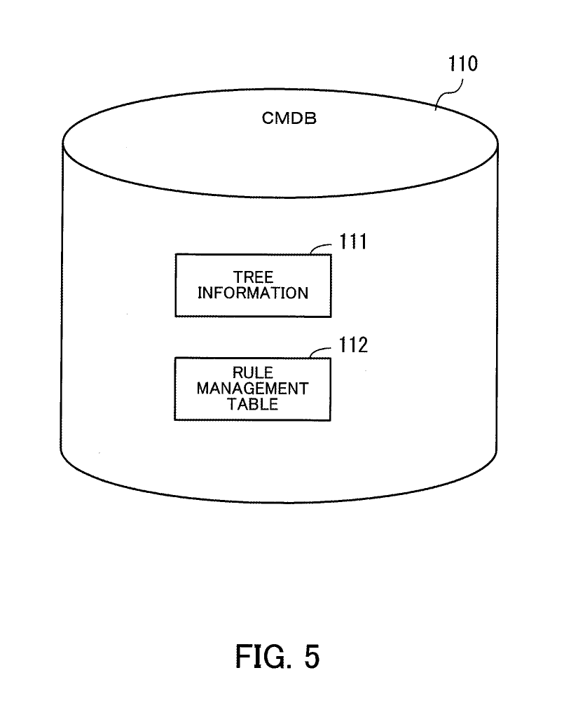

Information prestored in the management unit 100 is described next in detail. FIG. 5 illustrates an example of information stored in a configuration management database. The configuration management database 110 stores therein tree information 111 and a rule management table 112. The tree information 111 represents connections among servers in the system in a hierarchical structure. The rule management table 112 is information indicating rules for standardization of configuration to be applied to configuration information.

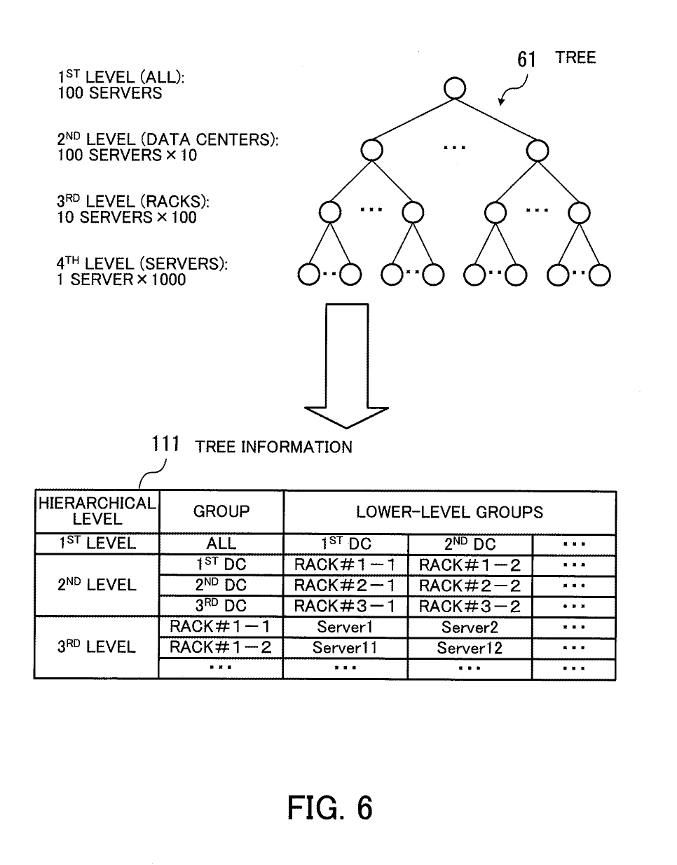

FIG. 6 illustrates an example of a data structure of tree information. The tree information 111 represents groups to which individual servers belong in a hierarchical tree structure (a tree 61). For example, the first hierarchical level includes only a single group ‘all’. The second hierarchical level includes a plurality of groups each corresponding to a different data center (DC). The third hierarchical level includes a plurality of groups each corresponding to a different server rack installed in the data centers. The fourth hierarchical level at the bottom includes individual servers. Note that the groups of the second embodiment are an example of the clusters in the first embodiment.

In the tree 61, each group includes all servers in any subtree below the group. For example, the group ‘all’ includes all servers of the system. Each data center group includes servers installed in a corresponding data center. Each rack group includes servers housed in a corresponding rack. Each server group is composed of a single server. Such a tree hierarchical structure is defined by the tree information 111.

The tree information 111 indicates the structure of the tree 61. In the example of FIG. 6, the tree information 111 includes columns named hierarchical level, group, and lower-level groups. In the hierarchical level column, each field contains a hierarchical level of the tree 61. In the group column, each field contains the name of a group (a cluster of apparatuses) belonging to a corresponding hierarchical level. In the lower-level group column, each field contains the name of a lower-level group belonging to a corresponding group. For example, in the lower-level group column, the fields corresponding to the group ‘all’ contain the groups of the individual data centers. Similarly, the fields corresponding to each of the data center groups contain groups of individual racks belonging to the data center group. The fields corresponding to each of the rack groups contain groups of individual servers belonging to the rack group.

Assume the following in the second embodiment: the system includes 1000 servers in total; 100 servers each are installed at ten data centers; and ten racks each housing ten servers are installed at each of the data centers.

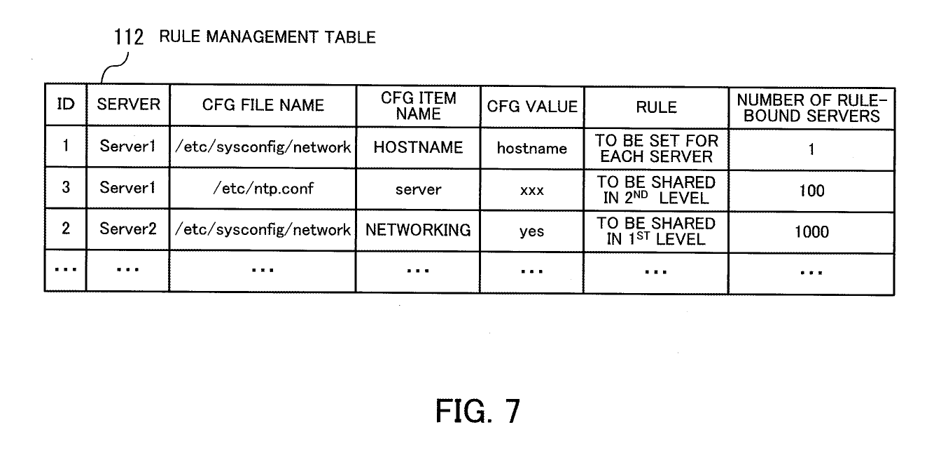

Next described is a data structure of the rule management table 112. FIG. 7 illustrates an example of a data structure of a rule management table. The rule management table 112 includes columns named identifier (ID), server, configuration file name, configuration item name, configuration value, rule, and number of rule-bound servers.

In the identifier column, each field contains an identification number of a rule. In the server column, each field contains the name of a server to which a corresponding rule is applied. In the configuration file name column, each field contains the location and name of a file in which information is set. In the configuration item name column, each field contains the name of configuration information (configuration item name) in a corresponding file. In the configuration value column, each field contains the value currently set for configuration information of a corresponding server.

In the rule column, each field contains the standard configuration rule for a value set for corresponding configuration information. Each rule defines, for example, a hierarchical level in which each group shares one common value for the corresponding configuration information. For example, when the rule is ‘to be shared in the first hierarchical level’, it is standard to set a common value for all the servers in the system. When the rule is ‘to be shared in the second hierarchical level’, it is standard to set a common value for all servers belonging to the same data center. When the rule is ‘to be set for each server’, it is standard to set a value individually for each server.

In the number of rule-bound servers column, each field contains the number of servers for which a common value is set when a corresponding rule is strictly followed. For example, when the rule is ‘to be shared in the first hierarchical level’, the number of rule-bound servers is the total number of servers in the system (1000 servers). When the rule is ‘to be shared in the second hierarchical level’, the number of rule-bound servers is the number of servers in a data center to which a corresponding server appearing in the server column belongs (100 servers). When the rule is ‘to be set for each server’, the number of rule-bound servers is 1.

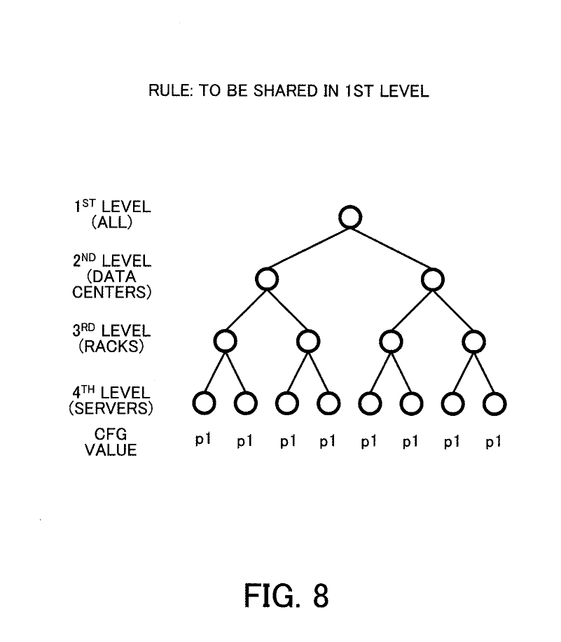

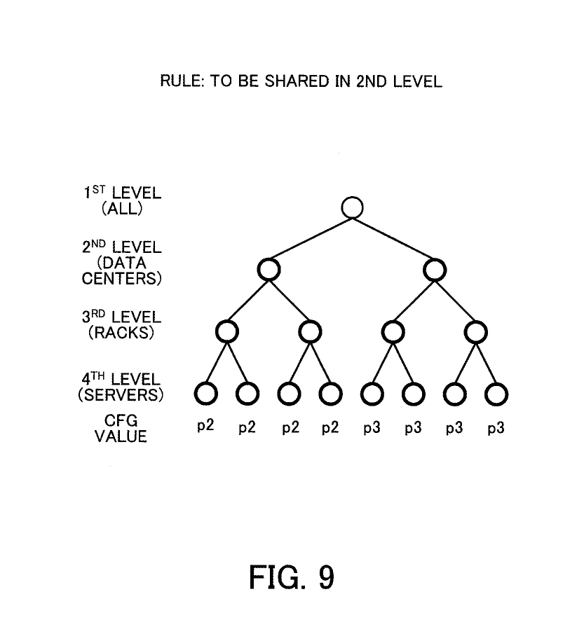

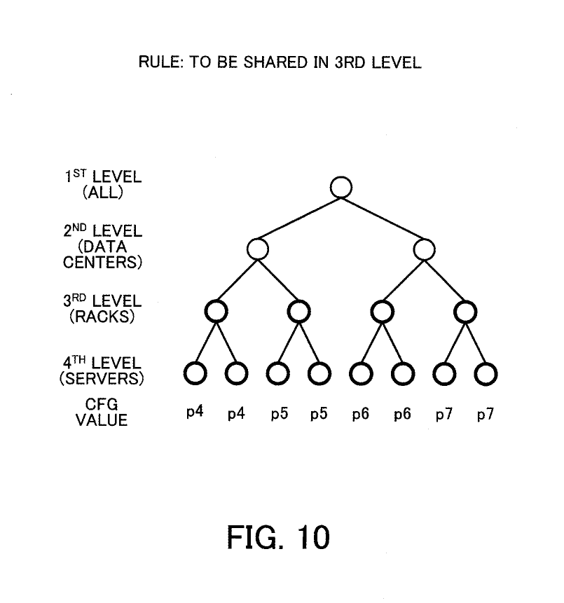

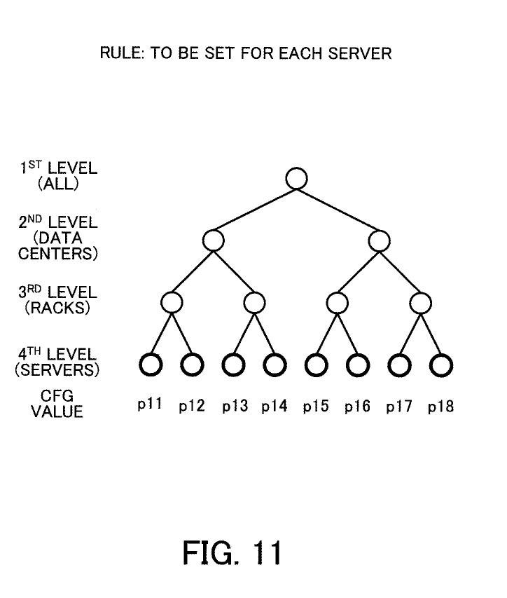

Examples of the application of rules are described next with reference to FIGS. 8 to 11. FIG. 8 illustrates an example of the application of the rule ‘to be shared in the first hierarchical level’. If the rule ‘to be shared in the first hierarchical level’ is strictly followed, a common value is set for servers belonging to the group ‘all’ in the first hierarchical level (i.e., all the servers in the system). FIG. 9 illustrates an example of the application of the rule ‘to be shared in the second hierarchical level’. If the rule ‘to be shared in the second hierarchical level’ is strictly followed, a common value is set for servers belonging to the same data center. FIG. 10 illustrates an example of the application of the rule ‘to be shared in the third hierarchical level’. If the rule ‘to be shared in the third hierarchical level’ is strictly followed, a common value is set for servers installed in the same rack. FIG. 11 illustrates an example of the application of the rule ‘to be set for each server’. If the rule ‘to be set for each server’ is strictly followed, a value is set individually for each server.

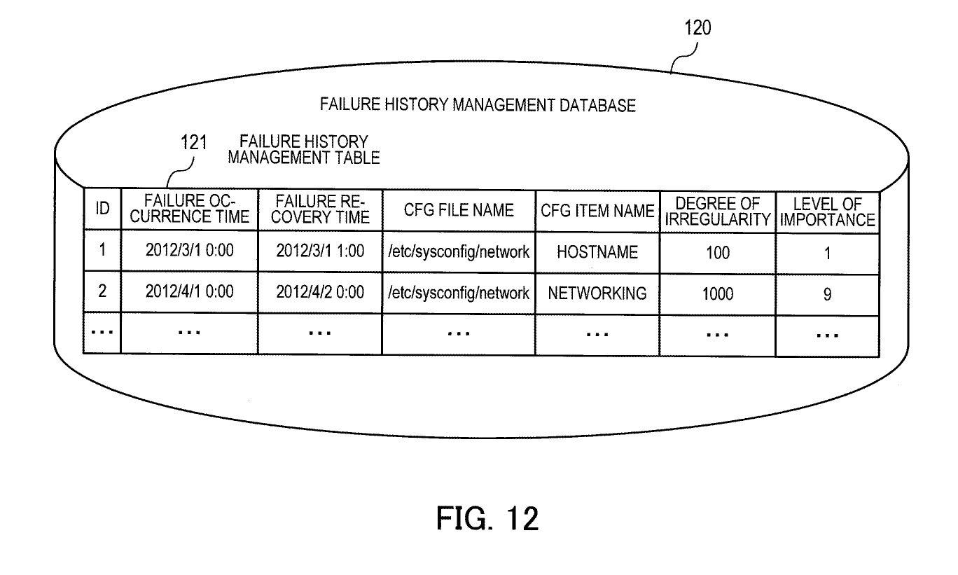

The failure history management database 120 is described next in detail. FIG. 12 illustrates an example of a data structure of a failure history management database. The failure history management database 120 stores therein a failure history management table 121, which includes columns named identifier (ID), failure occurrence time, failure recovery time, configuration file name, configuration item name, degree of irregularity, and level of importance.

In the identifier column, each field contains an identification number of a failure history record. In the failure occurrence time column, each field contains the time and data of the occurrence of a corresponding failure. In the failure recovery time column, each field contains the time and date of recovery from a corresponding failure. In the configuration file name column, each field contains the location and name of a file in which a configuration change having caused a corresponding failure was made. In the configuration item name column, each field contains the name of configuration information for which a configuration change having caused a corresponding failure was made. In the degree of irregularity column, each field contains the degree of irregularity of a configuration change having caused a corresponding failure. The method for calculating the degree of irregularity for each failure history record is the same as the method for calculating the degree of irregularity by the irregularity calculating unit 141. In the level of importance column, each field contains the level of importance of a corresponding failure. For example, a higher value is assigned to a failure with higher level of importance.

Note that the example of FIG. 12 illustrates failure history records whose failures were caused by configuration changes, however, the failure history management table 121 may include failure history records with failures due to other causes. As for failure history records with failures due to causes other than configuration changes, fields in the configuration file name column and the configuration item name column, for example, are left blank in the failure history management table 121. In addition, for failure history records with failures due to causes other than configuration changes, the failure history management table 121 may include an additional column to register details of the causes.

Using the databases with the contents described above, the degree of risk involved in a configuration change is predicted by the cooperation of the user interface 130, the irregularity calculating unit 141, the importance predicting unit 142, the risk determining unit 143, and the risk displaying unit 144.

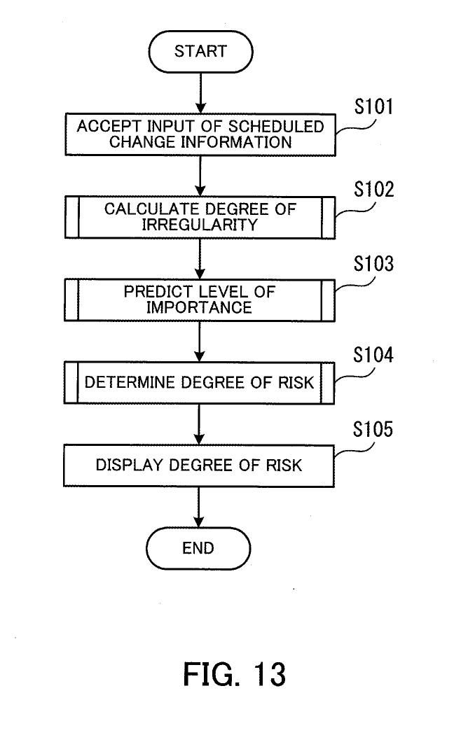

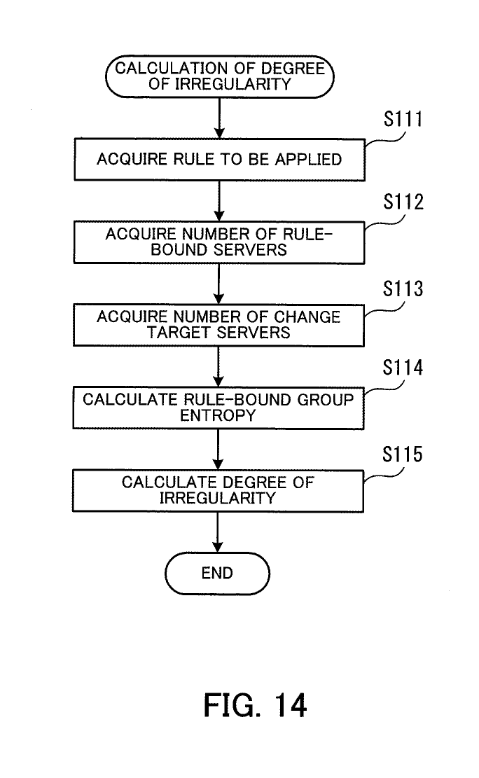

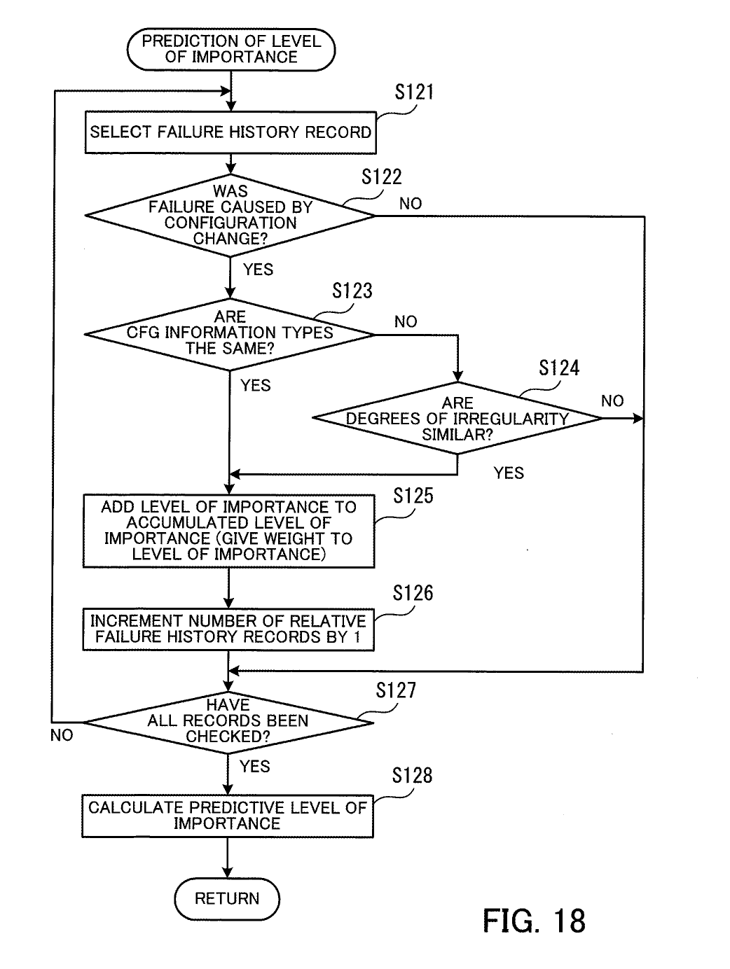

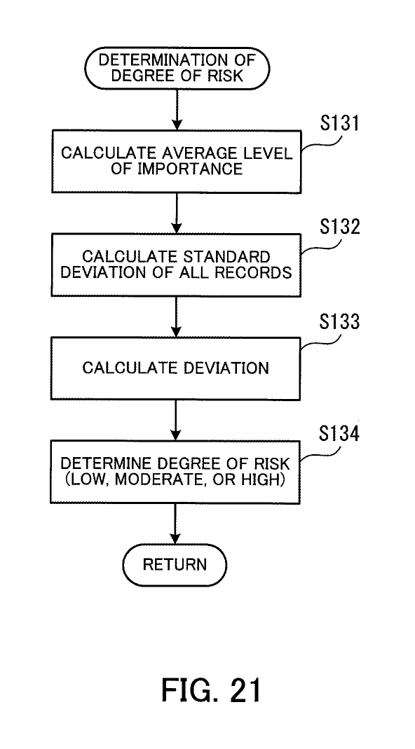

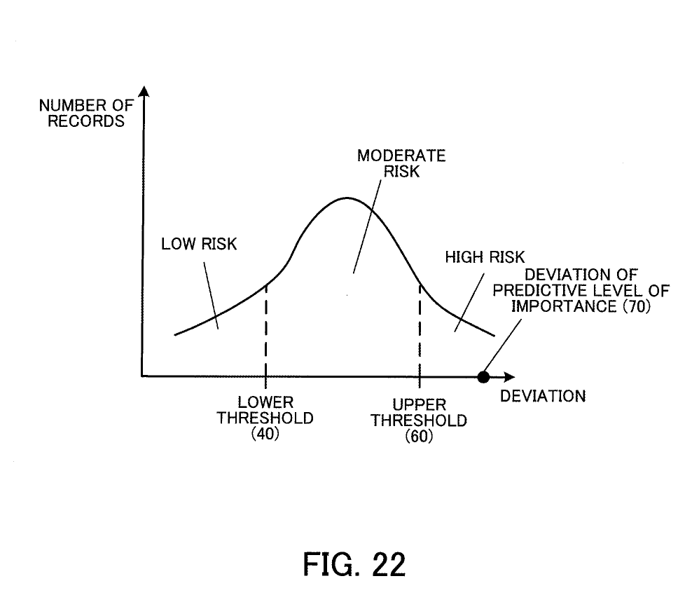

FIG. 13 is a flowchart illustrating an example of a procedure for predicting the degree of risk.

[Step S101] The user interface 130 accepts an input of configuration information change content for one or more servers. For example, the user interface 130 displays a scheduled change information input screen on the monitor 21. Then, the user interface 130 acquires change content input by a user in an input field provided on the scheduled change information input screen. The user interface 130 transmits the acquired change content to the irregularity calculating unit 141 as scheduled change information. The scheduled change information includes, for example, a change target server, a configuration file name, a configuration item name, and a configuration value.

[Step S102] Based on the acquired scheduled change information, the irregularity calculating unit 141 calculates the degree of irregularity obtained when the configuration change is applied. The irregularity calculating unit 141 transmits the irregularity calculation result to the importance predicting unit 142. Note that the details of the irregularity calculation process are described later (see FIGS. 14 to 17).

[Step S103] Based on the irregularity calculation result, the importance predicting unit 142 searches the failure history management database 120 for relevant failure history records, and then predicts the level of importance based on the search result. Subsequently, the importance predicting unit 142 transmits the acquired predictive level of importance to the risk determining unit 143. Note that the details of the importance prediction process are described later (see FIGS. 18 to 20).

[Step S104] Based on the predictive level of importance, the risk determining unit 143 determines the degree of risk of failure occurrence due to applying the configuration change. The risk determining unit 143 transmits the risk determination result to the risk displaying unit 144. Note that the details of the risk calculation process are described later (see FIGS. 21 and 22).

[Step S105] The risk displaying unit 145 displays the acquired risk determination result on the monitor 21. This allows the administrator to quantitatively understand the degree of risk due to application of the configuration change.

The individual processes of steps S102 to S104 of FIG. 13 are described next in detail.

Calculation of Degree of Irregularity

The degree of irregularity calculated according to the second embodiment has the following attributes, for example.

In the following cases, the degree of irregularity is low.
Degree of Irregularity ‘Low’ [Example 1]: when a change in the value of configuration information subject to the rule ‘to be set for each server’ is made for just one server.
Degree of Irregularity ‘Low’ [Example 2]: when a change in the value of configuration information subject to the rule ‘to be shared in the first hierarchical level’ is made for all the servers in such a manner that a new common value is set for the configuration information in all the servers.

In the following case, the degree of irregularity is high.
Degree of Irregularity ‘High’ [Example 1]: when a change in the value of configuration information subject to the rule ‘to be shared in the first hierarchical level’ is made for just one server.

In the following case, the degree of irregularity is moderate.
Degree of Irregularity ‘Moderate’ [Example 1]: when a change in the value of configuration information shared at an intermediate level, subject to the rule ‘to be shared in the second hierarchical level’ or ‘to be share in the third hierarchical level’, is made for just one server.

The degree of irregularity is found, for example, by the following calculation expression:

Degree of Irregularity=(Number of Rule-bound Servers)/(Number of Change Target Servers)/(1+Rule-bound Group Entropy). (1)

The number of rule-bound servers is obtained from the rule management table 112. The number of change target servers is the number of servers to undergo a configuration change, designated by the scheduled change information. The rule-bound group entropy is the entropy (average amount of information) of configuration information of a server group subject to the same rule. The entropy is a measure of the degree of divergence in the probability of occurrence of information. If one piece of information has a probability of occurrence of 1, then the entropy is 0. When each of a plurality of information pieces has a probability of occurrence of less than 1, the entropy takes a positive real number. In addition, the entropy is lower if there is a larger deviation in the occurrence frequencies of a plurality of information pieces. The rule-bound group entropy is given by the following expression:

Rule-bound Group Entropy=−ΣP(A)log P(A) (2)

where P(A) is the probability of occurrence of a value (A) currently set for a change-target configuration information type in servers to which a rule associated with the configuration information type is applied. Σ is the summation operator, and the base of the logarithm is, for example, 2. In the case where the value of the change-target configuration information type is shared by all the servers subject to the rule, the rule-bound group entropy is 0. As the number of servers with values diverging from the rule increases, the rule-bound group entropy takes a larger value. That is, the rule-bound group entropy indicates the degree of divergence from the rule before the configuration change.

Next described is a procedure for calculating the degree of irregularity. FIG. 14 is a flowchart illustrating an example of a procedure for calculating the degree of irregularity.

[Step S111] The irregularity calculating unit 141 acquires a rule to be applied to the change-target configuration information type. For example, the irregularity calculating unit 141 searches the rule management table 112 stored in the configuration management database 110 for a record whose content matches the change target server, configuration file name, and configuration item name designated by the scheduled change information. Then, the irregularity calculating unit 141 acquires a rule registered in the record found in the search.

[Step S112] The irregularity calculating unit 141 acquires the number of servers to which the acquired rule is applied (i.e., the number of rule-bound servers). For example, the irregularity calculating unit 141 acquires the number of rule-bound servers from the record found in the search in step S111.

[Step S113] The irregularity calculating unit 141 acquires the number of change target servers. For example, the irregularity calculating unit 141 acquires the number of servers designated by the scheduled change information as change targets.

[Step S114] The irregularity calculating unit 141 calculates the rule-bound group entropy. The rule-bound group entropy may be calculated by the following procedure.

Based on the rule acquired in step S111, the irregularity calculating unit 141 determines a hierarchical level of a group to which the rule is applied. For example, if the rule is ‘to be shared in the first hierarchical level’, the rule is applied to all the servers belonging to the group in the first hierarchical level. If the rule is ‘to be shared in the second hierarchical level’, the rule is applied to servers belonging to a group in the second hierarchical level.

Next, referring to the tree information 111 stored in the configuration management database 110, the irregularity calculating unit 141 identifies, amongst groups in the determined hierarchical level, a group to which each of the change target servers belongs. For example, if the determined hierarchical level is the second hierarchical level, the irregularity calculating unit 141 identifies one of the groups in the second hierarchical level, to which the change target server belongs.

Further, referring to the rule management table 112, the irregularity calculating unit 141 calculates the occurrence rate of each configuration value currently set for the same configuration information type as that of the scheduled change configuration information, in all the servers belonging to the determined group. Here, the same configuration information type as that of the scheduled change information means configuration information having the same configuration file name and configuration item name as those designated by the scheduled change information. The occurrence rate of each configuration value is obtained by dividing the number of servers having the configuration value within the identified group by the total number of servers belonging to the identified group.

Subsequently, the irregularity calculating unit 141 plugs the occurrence rate of each configuration value in Equation (2) to calculate the rule-bound group entropy.

[Step S115] The irregularity calculating unit 141 calculates the degree of irregularity. For example, the irregularity calculating unit 141 plugs, into the right-hand side of Equation (1), the number of rule-bound servers, the number of change target servers, and the rule-bound group entropy acquired in step S112 to S114, to thereby obtain the degree of irregularity.

In the above-described manner, the degree of irregularity is calculated. Next described are examples of calculating the degree of irregularity.

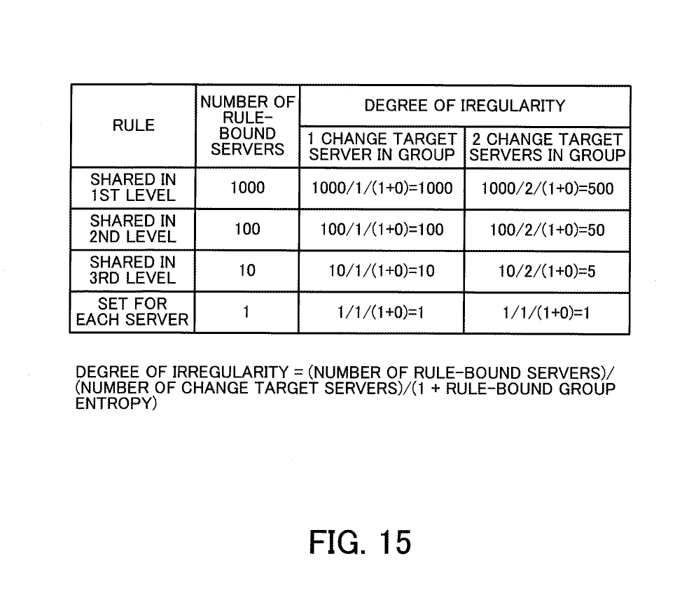

FIG. 15 illustrates differences in the degree of irregularity according to the number of rule-bound servers and the number of change target servers. Assume that, in the examples of FIG. 15, all the servers belonging to a group including one or more change target servers have the same value set for a change-target configuration information type. Specifically, the examples assume the case where a configuration change is carried out for one or two servers in a group when the rule-bound group entropy is 0.

For example, in the case where a change is made in the value of a configuration information type subject to the rule ‘to be shared in the first hierarchical level’, the degree of irregularity is 1000 if the number of change target servers is one, and the degree of irregularity is 500 if the number of change target servers is two. In the case where a change is made in the value of a configuration information type subject to the rule ‘to be shared in the second hierarchical level’, the degree of irregularity is 100 if the number of change target servers is one, and the degree of irregularity is 50 if the number of change target servers is two. In the case where a change is made in the value of a configuration information type subject to the rule ‘to be shared in the third hierarchical level’, the degree of irregularity is 10 if the number of change target servers is one, and the degree of irregularity is 5 if the number of change target servers is two. In the case where a change is made in the value of a configuration information type subject to the rule ‘to be set for each server’, the degree of irregularity is 1 whether the number of change target servers is one or two.

Thus, when the number of change target servers remains the same, the degree of irregularity takes a larger value as the number of rule-bound servers increases. In addition, when the number of rule-bound servers remains the same, the degree of irregularity takes a smaller value as the number of change target servers increases.

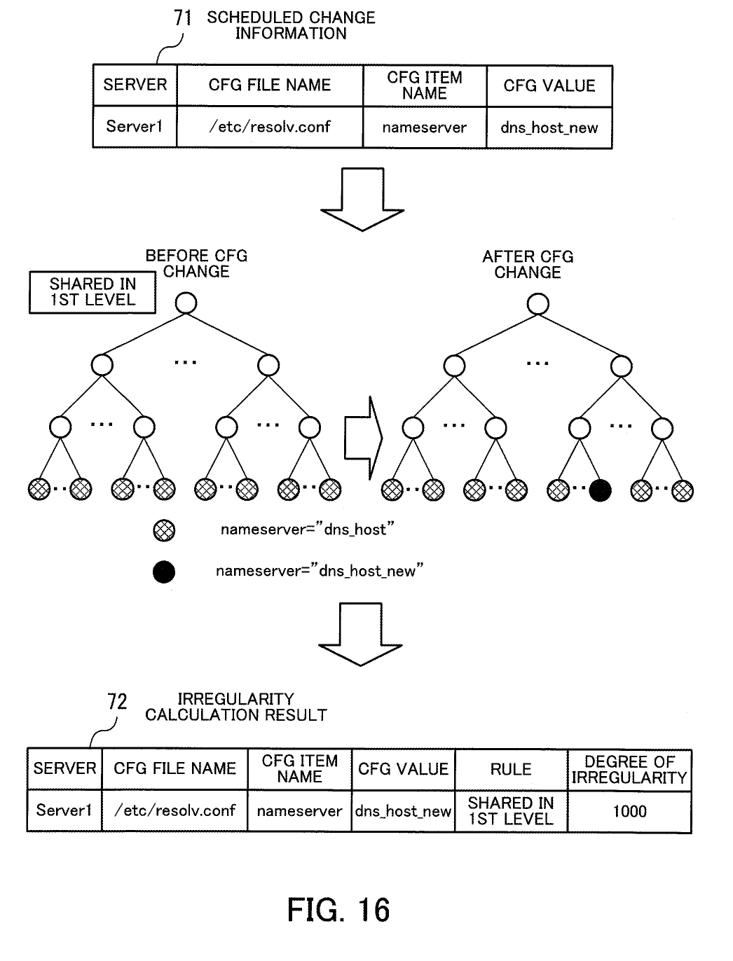

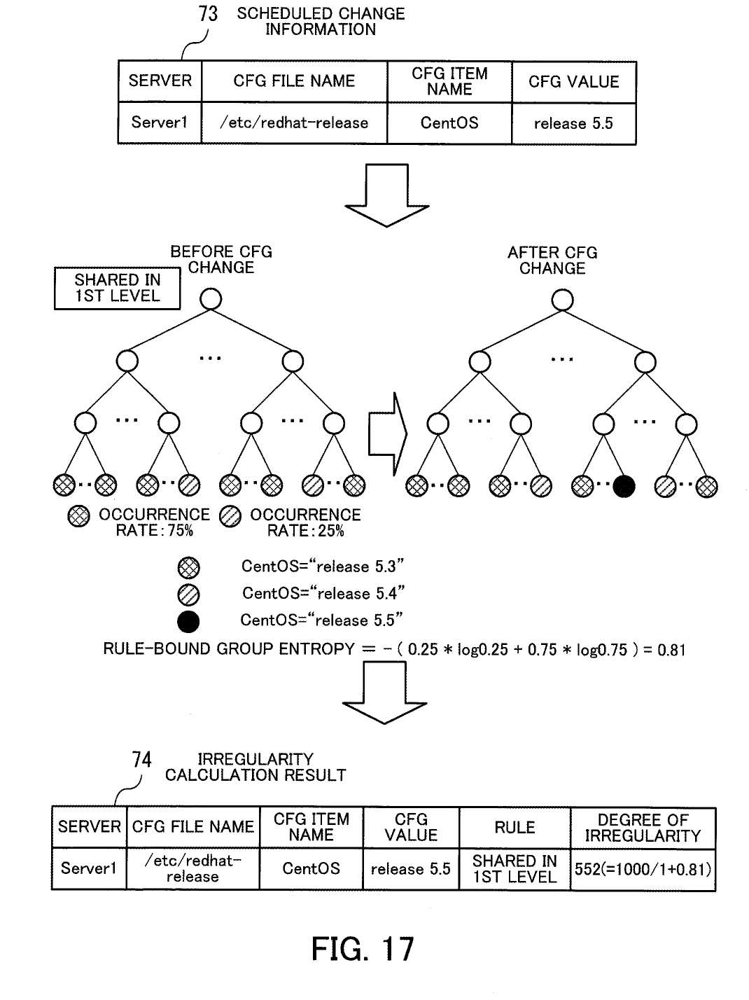

Next described are differences in the degree of irregularity according to the rule-bound group entropy, with reference to FIGS. 16 and 17. FIG. 16 illustrates an example of calculating the degree of irregularity in the case of the rule-bound group entropy being 0. Assume that, in the example of FIG. 16, scheduled change information designates, as a change target, a configuration information type subject to the rule ‘to be shared in the first hierarchical level’. That is, this standard configuration rule states to set a common value for an associated configuration information type of all the servers in the system, which configuration information type is identified by the configuration file name and the configuration item name designated by the scheduled change information 71. Note also that the scheduled change information 71 designates one server as a change target server.

Assume here that the configuration value is common across all the servers prior to the configuration change. That is, all servers subject to the rule have a common configuration value, and therefore the rule-bound group entropy is 0. In this case, the degree of irregularity is 1000 if the total number of servers in the system is 1000.

The calculated degree of irregularity is presented in an irregularity calculation result 72. The irregularity calculation result 72 includes, for example, information of the server, the configuration file name, the configuration item name, the configuration value, and the rule in addition to the degree of irregularity.

FIG. 17 illustrates an example of calculating the degree of irregularity in the case of the rule-bound group entropy being 0.81. Assume that, in the example of FIG. 17, scheduled change information 73 designates, as a change target, a configuration information type subject to the rule ‘to be shared in the first hierarchical level’. Note also that the scheduled change information 73 designates one server as a change target server.

Prior to the configuration change, in each of all the servers, one of two configuration values is set for the same configuration information type as that of the change target. One of the configuration values has an occurrence rate of 75% while the other has an occurrence rate of 25%. In this case, the rule-bound group entropy is 0.81. Using the rule-bound group entropy, the degree of irregularity is calculated to be 552 if the total number of servers in the system is 1000.

As is seen by comparing FIGS. 16 and 17, the degree of irregularity changes depending on the value of the rule-bound group entropy even when the configuration change pattern is apparently similar to each other, i.e., a configuration change of one server within a group with regard to a configuration information type subject to the rule ‘to be shared in the first hierarchical level’. That is, when there is a high degree of homogeneity in the values of the change-target configuration information type across the group prior to the configuration change, the rule-bound group entropy is low, which results in a high degree of irregularity. On the other hand, when there is a low degree of homogeneity in the values of the change-target configuration information type prior to the configuration change, the rule-bound group entropy is high, resulting in a low degree of irregularity.

As illustrated in FIG. 17, representing the common value distribution of the configuration information type before the configuration change by the rule-bound group entropy allows the degree of irregularity to be lower with lower uniformity in the values of the configuration information type before the configuration change. As a result, different degrees of irregularity are obtained for apparently similar configuration change situations (in the above-described example, a configuration change of one server within a group with regard to a configuration information type subject to the rule ‘to be shared in the first hierarchical level’), as illustrated in FIGS. 16 and 17.

By adopting the degree of irregularity described above to predict the degree of risk, it is possible to assess the risk of the configuration change quantitatively with reference to past configuration changes each having a similar degree of divergence from its standard configuration value.

Prediction of Level of Importance

Once the degree of irregularity is calculated, the level of importance is predicted using the calculated degree of irregularity. FIG. 18 is a flowchart illustrating an example of a procedure for predicting the level of importance.

[Step S121] The importance predicting unit 142 selects one untreated record amongst records in the failure history management table 121.

[Step S122] The importance predicting unit 142 determines whether a failure indicated by the selected record was caused by a configuration change. For example, if the failure history record includes a configuration item name, the importance predicting unit 142 determines that a configuration change caused the failure. On the other hand, if the failure history record has a blank configuration item name field, the importance predicting unit 142 determines that the failure was caused by something other than a configuration change. If the failure was due to a configuration change, the process moves to step S123. If the failure arose from something other than a configuration change, the process moves to step S127.

[Step S123] The importance predicting unit 142 determines whether, in the failure history indicated by the selected record, the configuration information type subject to the configuration change having caused the failure matches the configuration information type designated by the scheduled change information. For example, the configuration information types are determined to be the same if the configuration file name and the configuration item name of the selected record match those of the scheduled change information. If the configuration information types are the same, the process moves to step S125. If the setting information types are not the same, the process moves to step S124.

[Step S124] The importance predicting unit 142 determines whether the degree of irregularity indicated by the selected record is similar to the degree of irregularity calculated for the configuration change designated by the scheduled change information. For example, the importance predicting unit 142 determines that these degrees of irregularity are similar if the difference between the degree of irregularity of the selected record and the degree of irregularity calculated in step S102 (see FIG. 13) falls within a predetermined range. If the degrees of irregularity are similar, the process moves to step S125. If not, the process moves to step S127.

[Step S125] When the configuration information types are determined to be the same (YES in step S123) or when the degrees of irregularity are determined to be similar to each other (YES in step S124), the importance predicting unit 142 designates the history information indicated by the selected record as a relevant failure history record. Then, the importance predicting unit 142 adds the level of importance of the selected record to an accumulated level of importance. Note that the accumulated level of importance is the sum of the level of importance of relevant failure history records, which is set to an initial value of 0 at the start of the importance prediction process.

When adding the level of importance, the importance predicting unit 142 may give a weight to the level of importance according to the degree of irregularity. For example, the importance predicting unit 142 gives a larger weight when there is a smaller difference between the degree of irregularity of the relative failure history record and the degree of irregularity calculated based on the scheduled change information. Then, the importance predicting unit 142 adds, to the accumulated level of importance, the result obtained by multiplying the level of importance of the relative failure history record by the weight.

[Step S126] The importance predicting unit 142 adds 1 to the number of relative failure history records. The number of relative failure history records represents the number of failure history records determined as relative failure history records, which is set to an initial value of 0 at the start of the importance prediction process.

[Step S127] The importance predicting unit 142 determines whether the process of checking to see if a failure history record is a relative failure history record (steps S122 to S125) has been carried out for all the records in the failure history management table 121. If there is an unchecked record, the process moves to step S121. If all the records have been checked, the process moves to step S128.

[Step S128] Using the accumulated level of importance and the relative failure history records, the importance predicting unit 142 calculates a predictive level of importance. For example, the importance predicting unit 142 uses, as the predictive level of importance, the average of the level of importance obtained by dividing the accumulated level of importance by the number of relative failure history records.

In the above-described manner, including history records each having a similar degree of irregularity to that of the scheduled change information into the relative failure history records allows calculation of an appropriate predictive level of importance, for example, even when no failure caused by a configuration change of the configuration information type designated by the scheduled change information has previously taken place.

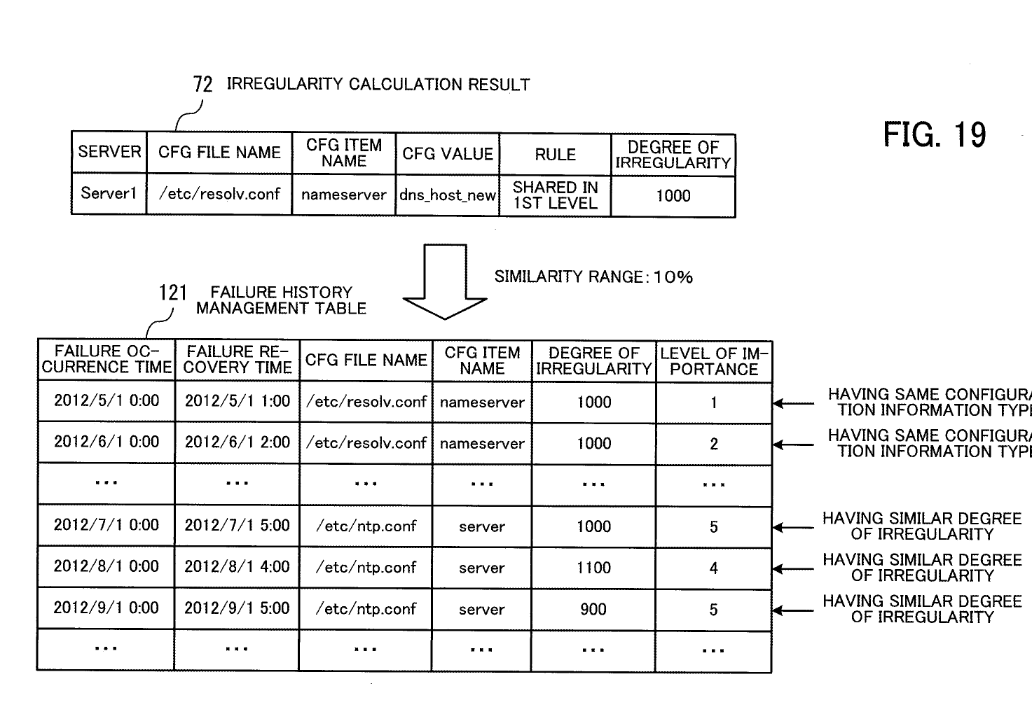

FIG. 19 illustrates a first example of extracting relative failure history records. According to the example of FIG. 19, the degree of irregularity is 1000 in the irregularity calculation result 72 obtained for the scheduled change information 71. In this case, the similarity range of the degree of irregularity used to determine relative failure history records is a range of plus or minus 10% of the degree of irregularity designated by the irregularity calculation result 72. In the example of FIG. 19, the range of the degree of irregularity between 900 and 1100 is the similarity range. Then, history records each having the same configuration information type (the same configuration file name and configuration item name) as that designated by the irregularity calculation result 72 and history records each having the degree of irregularity falling within the similarity range are extracted from the failure history management table 121 as relative failure history records.

Once the relative failure history records are extracted, the predictive level of importance is calculated based on the relative failure history records. A predictive level of importance R is defined by the following expression:

R={R(e)+R(ne)}/(Number of Relative Failure History Records). (3)

In the expression, R(e) is the accumulated level of importance of history records having the same configuration information type. For example, in the case where there are two history records having the same configuration information type and individually having a level of importance of 1 and 2, R(e)=1+2=3.

R(ne) is the accumulated level of importance of history records not having the same configuration information type but each having a similar degree of irregularity. For example, in the case where there are six history records each having a similar degree of irregularity and the sum of the level of importance of the history records is 29, R(ne)=29.

In the case of two history records each having the same configuration information type, six history records each having a similar degree of irregularity, R(e)=3, and R(ne)=29, the predictive level of importance R is: R=(3+29)/8=4.0.

Thus, by adding the level of importance of history records each having a similar degree of irregularity to the accumulated level of importance, it is possible to calculate an appropriate predictive level of importance even for a configuration change to a configuration information type for which no failure history records exist.

In addition, according to the second embodiment, the degree of irregularity is calculated using the rule-bound group entropy. Therefore, even for apparently similar configuration change situations, different degrees of irregularity are obtained, depending on the distribution of values of the configuration information type before the change. Due to the difference in the degree of irregularity, history records to be extracted as relevant failure history records also change.

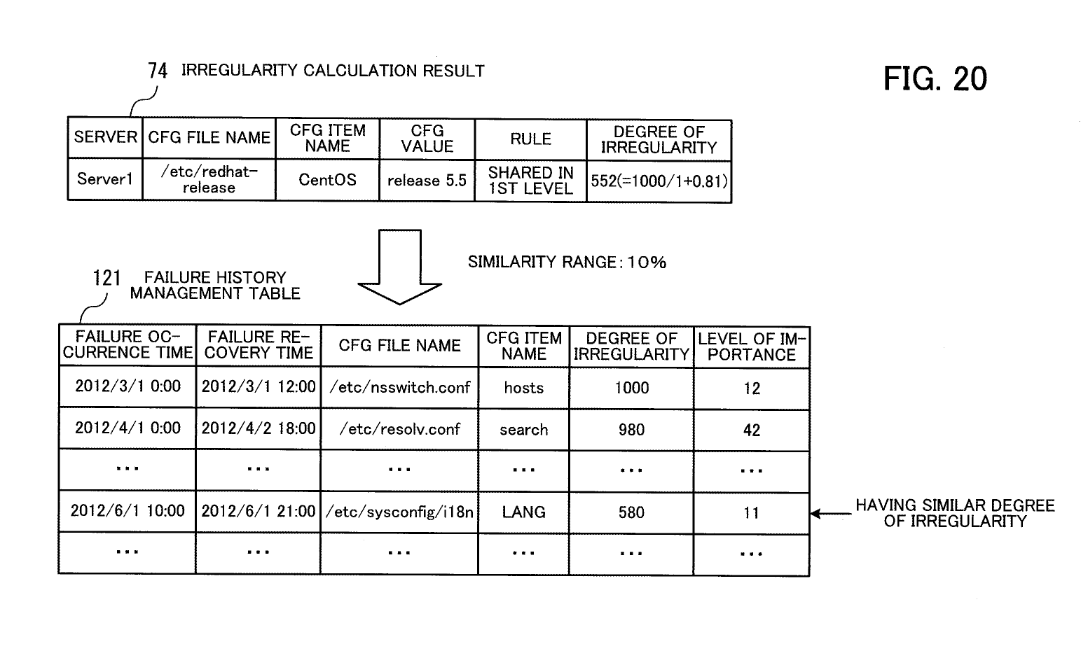

FIG. 20 illustrates a second example of extracting relative failure history records. According to the example of FIG. 20, the degree of irregularity is 552 in the irregularity calculation result 74 obtained for the scheduled change information 73. In this case, the similarity range of the degree of irregularity used to determine relative failure history records is a range of plus or minus 10% of the degree of irregularity designated by the irregularity calculation result 74. In the example of FIG. 20, the range of the degree of irregularity between 497 and 607 is the similarity range. Then, history records each having the same configuration information type (the same configuration file name and configuration item name) as that designated by the irregularity calculation result 74 and history records each having the degree of irregularity falling within the similarity range are extracted from the failure history management table 121 as relative failure history records.

This allows configuration change situations to be broken down into more exact patterns. For example, in the case of changing a value of configuration information during system migration, servers in the system may have a plurality of different versions of operating systems before the configuration change. During system migration in such an environment, the servers may also temporarily have a plurality of different language settings, in addition to the different versions of operating systems, because tests are carried out in a multi-language environment.

According to the example of FIG. 20, the failure history management table 121 includes a failure history record with a configuration file name Vetc/sysconfig/i18n′ and a configuration item name ‘LANG’, the failure of which is associated with a language setting. The failure history record represents a failure, for example, caused by a configuration change in an environment where both LANG=en JP.UTF-8 (80%) and LANG=en DE.UTF-8 (20%) were present.

Such a failure history record becomes useful in predicting the level of importance of a failure due to a configuration change in the version of an operating system. According to the second embodiment, the rule-bound group entropy is used to calculate the degree of irregularity, and it is therefore possible to extract, as relative failure history records, history records each having a similar occurrence frequency pattern of values of a change-target configuration information type before a configuration change and use the extracted relative failure history records to calculate the predictive level of importance. That is, the predictive level of importance is calculated based on the failure history records each obtained in an environment where the distribution of values of a change-target configuration information type is similar to that of the scheduled configuration change. As a result, the accuracy of the predictive level of importance is improved.

Determination of Degree of Risk

Based on the calculated predictive level of importance, the degree of risk of the scheduled configuration change is determined. For example, the risk determining unit 143 assesses the deviation of the predictive level of importance based on the level of importance of all records in the failure history management table 121. Then, the risk determining unit 143 determines the degree of risk based on the deviation. The relationship between the deviation and the degree of risk is as follows.
deviation<lower threshold: low degree of risk
lower threshold≦deviation<upper threshold: moderate degree of risk
deviation≧upper threshold: high degree of risk

The thresholds may take any values. For example, the lower threshold is 40 and the upper threshold is 60. Next described is a procedure for determining the degree of risk.

FIG. 21 is a flowchart illustrating an example of a procedure for determining the degree of risk.

[Step S131] The risk determining unit 143 calculates the average of the levels of importance of all the records in the failure history management table 121.

[Step S132] The risk determining unit 143 calculates the standard deviation of the levels of importance of all the records in the failure history management table 121.

[Step S133] The risk determining unit 143 calculates the deviation of the predictive level of importance based on the predictive level of importance, the average level of importance, and the standard deviation. Note that the deviation is defined by the following calculation expression:

Deviation={10×(Predictive Level of Importance Average Level of Importance)}/Standard Deviation+50. (4)

[Step S134] The risk determining unit 143 compares the deviation of the predictive level of importance and the thresholds to thereby determine the degree of risk (low, moderate, or high).

In the above-described manner, the degree of risk is determined. For example, when the predictive level of importance (downtime) is 40 hours, the average level of importance (average actual downtime) is 20 hours, and the standard deviation is 10 hours, Deviation={10×(40−20)}/10+50=70. The deviation obtained in this manner is compared with the lower and upper thresholds to thereby determine the degree of risk.

FIG. 22 illustrates an example of determination of the degree of risk. FIG. 22 illustrates deviation distribution associated with the level of importance of all the records in the failure history management table 121. The horizontal axis represents the deviation, and the vertical axis represents the number of records. According to the example of FIG. 22, the lower and upper thresholds used to determine the degree of risk are 40 and 60, respectively. In this case, if the deviation of the predictive level of importance is less than 40, the degree of risk is determined to be low. If the deviation of the predictive level of importance is 40 or more and less than 60, the degree of risk is determined to be moderate. If the deviation of the predictive level of importance is 60 or more, the degree of risk is determined to be high. For example, the deviation of the predictive level of importance being 70 is determined to be a high degree of risk.

The risk display unit 144 displays the determination result of the degree of risk on the monitor via the user interface 130. As a result, the administrator having input the scheduled change information is able to understand the degree of risk involved in implementing the configuration change designated by the scheduled change information.

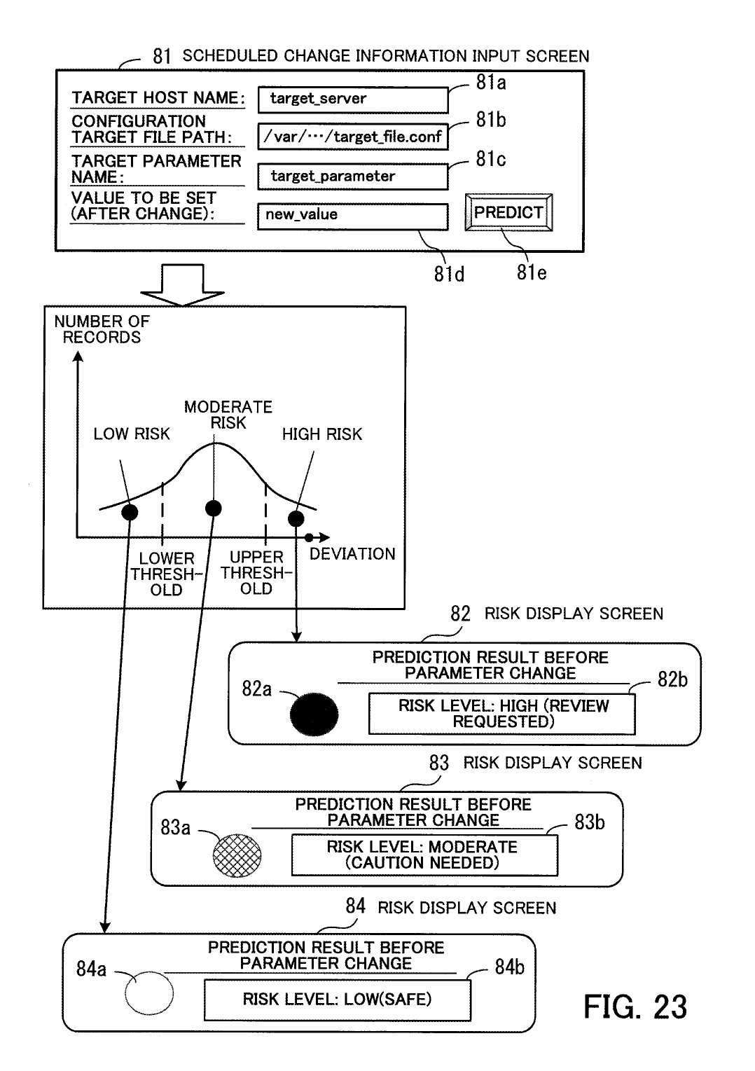

FIG. 23 illustrates an example of a screen transition from a screen for inputting scheduled change information to a screen for displaying the degree of risk. For example, in the case where the administrator inputs the scheduled change information, a scheduled change information input screen 81 is displayed on the monitor 21.

The scheduled change information input screen 81 is provided with a plurality of text boxes 81a to 81d and a button 81e. The text box 81a is an input field for entering a target host name. The text box 81b is an input field for entering a file path to a configuration target file. The text box 81c is an input field for entering a configuration information name (configuration item name) of the configuration target. The text box 81d is an input field for entering a configuration value to be set. The button 81e is a button for instructing the risk prediction process to be executed.

The administrator inputs configuration change content in the text boxes 81a to 81d, and presses the button 81e when the input is completed. In response to the press of the button 81e, a prediction is made for the degree of risk involved in the configuration change indicated by the content entered into the text boxes 81a to 81d.

Note that the host name, configuration target file path, and configuration item name may be entered using selection boxes in place of the text boxes. For example, each selection box displays a pull-down menu with input information options. The administrator is able to select information to be input amongst the options displayed in the pull-down menu.

Once the degree of risk is determined, one of risk display screens 82 to 84 presenting the determination result is displayed on the monitor 21. The risk display screens 82 to 84 are provided with signals 82a, 83a, and 84a, respectively, each indicating the degree of risk. Each of the signals 82a, 83a, and 84a has a color according to the degree of risk. For example, the signal 82a indicating a high degree of risk lights up or is flashing in red. The signal 83a indicating a moderate degree of risk lights up or is flashing, for example, in yellow. The signal 84a indicating a low degree of risk lights up, for example, in green. The colors of the signals 82a, 83a, and 84a illustrated here are the same as traffic lights. Displaying the degree of risk using these colors allows the administrator to intuitively understand the risk of a failure due to the configuration change.

In addition, the risk display screens 82 to 84 are provided with message display parts 82b, 83b, and 84b, respectively, each indicating the degree of risk. For example, the message display part 82b of the risk display screen 82 indicating a high degree of risk displays a message reading ‘Degree of Risk: HIGH (review requested)’. The message display part 83b of the risk display screen indicating a moderate degree of risk displays a message reading ‘Degree of Risk: MODERATE (caution needed)’. The message display part 84b of the risk display screen 84 indicating a low degree of risk displays a message reading ‘Degree of Risk: LOW (safe)’. The display of such a message allows the administrator to readily recognize the degree of the risk.

In this way, the degree of risk is displayed in an easy-to-understand manner. As a result, the administrator is able to take a countermeasure according to the degree of risk before implementing a configuration change. Furthermore, according to the second embodiment, the degree of risk is appropriately determined even when no failure event due to implementation of a configuration change in a value of the same configuration information type has previously taken place. Note that if there is a failure event due to implementation of a configuration change in a value of the same configuration information type, a history record of the failure event is also used to calculate the predictive level of importance. Herewith, the accuracy of the predictive level of importance is improved.

Note that the failure history management database 120 described above stores therein history records associated with configuration changes having resulted in failures, however, history records associated with configuration changes having caused no failures may also be registered in the failure history management database 120. In that case, history records with a level of importance of 0, for example, are registered in the failure history management table 121. The registration of the history records associated with no failures changes the value of the predictive level of importance according to the number of configuration changes having caused no failures. For example, in the case where a number of history records associated with no failures (the level of importance being 0) are extracted as relevant failure history records, the average of the level of importance decreases and the predictive level of importance therefore decreases.

In the second embodiment, the example of changing the configuration information of the servers 41, 42, 43, and so on has been described in detail. However, the process according to the second embodiment is also applicable to the case of changing configuration information of the storage apparatuses 51, 52, and so on. Furthermore, the process according to the second embodiment is also applicable to configuration changes of various devices, such as switches.

While, as described above, the embodiments have been exemplified, the configurations of individual portions illustrated in the embodiments may be replaced with others having the same functions. In addition, another constituent element or process may be added thereto. Furthermore, two or more compositions (features) of the embodiments may be combined together.

According to one aspect, it is possible to determine the impact on a system due to a configuration change.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a management program that is used in managing a system including a plurality of apparatuses classified into a plurality of clusters and that causes a computer to perform a procedure comprising:
acquiring, based on scheduled change information indicating a scheduled change in configuration information of apparatuses accounting for a first rate amongst apparatuses belonging to a particular one of the clusters, one or more history records each associated with a change in the configuration information of apparatuses accounting for a second rate amongst apparatuses belonging to one of the clusters from a memory storing history records each including content related to a change in the configuration information of at least one or more apparatuses amongst apparatuses belonging to one of the clusters, the second rate satisfying a predetermined similarity relationship with the first rate; and
predicting, based on the acquired history records, an impact on the system due to implementing the scheduled change indicated by the scheduled change information.

2. The non-transitory computer-readable storage medium according to claim 1,
wherein the plurality of clusters formed by classifying the plurality of apparatuses in the system are organized into hierarchical levels, and with respect to each type of the configuration information, a rule is defined for a hierarchical level in which apparatuses belonging to one of the clusters share a common value for a value of the type of the configuration information, and
the scheduled change information designates at least one apparatus to undergo the scheduled change and a type of the configuration information whose value is to be changed, and
the procedure further includes:
identifying, based on the scheduled change information, a cluster to which the at least one apparatus belongs amongst clusters in the hierarchical level indicated by the rule applied to the type of the configuration information whose value is to be changed, and determining a proportion of the at least one apparatus to apparatuses belonging to the identified cluster as the first rate.

3. The non-transitory computer-readable storage medium according to claim 2,
wherein the acquiring includes further acquiring, from the memory, one or more history records each associated with a change in the same type of the configuration information as the type of the configuration information whose value is to be changed.

4. The non-transitory computer-readable storage medium according to claim 1,
wherein the predicting includes reflecting, in the predicting, more strongly the content of each of the acquired history records whose second rate has a higher degree of similarity to the first rate.

5. The non-transitory computer-readable storage medium according to claim 2,
wherein the acquiring includes
comparing, amongst the configuration information of each of the apparatuses belonging to the particular one of the clusters, values of the same type of the configuration information as the type of the configuration information whose value is to be changed to thereby calculate a degree of divergence from the rule, and
using a result of the calculation to determine whether the second rate satisfies the predetermined similarity relationship with the first rate.

6. The non-transitory computer-readable storage medium according to claim 1,
wherein each of the history records stored in the memory includes a magnitude of an impact on the system due to implementing the change in the configuration information, and
the predicting includes predicting a magnitude of the impact on the system due to implementing the scheduled change.

7. The non-transitory computer-readable storage medium according to claim 6,
wherein each of the history records stored in the memory includes a level of importance of a failure caused by the change in the configuration information, and
the predicting includes predicting the magnitude of the impact on the system due to implementing the scheduled change based on the level of importance indicated by the acquired history records.

8. The non-transitory computer-readable storage medium according to claim 7,
wherein the predicting includes determining a risk level of the scheduled change by
predicting, based on the level of importance indicated by the acquired history records, the level of importance of a failure caused by implementing the scheduled change,
calculating a deviation of the predicted level of importance based on distribution of the level of importance indicated by the acquired history records, and
comparing the deviation with a predetermined threshold.

9. A management method for managing a system including a plurality of apparatuses classified into a plurality of clusters, the management method comprising:
acquiring, by a processor, based on scheduled change information indicating a scheduled change in configuration information of apparatuses accounting for a first rate amongst apparatuses belonging to a particular one of the clusters, one or more history records each associated with a change in the configuration information of apparatuses accounting for a second rate amongst apparatuses belonging to one of the clusters from a memory storing history records each including content related to a change in the configuration information of at least one or more apparatuses amongst apparatuses belonging to one of the clusters, the second rate satisfying a predetermined similarity relationship with the first rate; and
predicting, by the processor, an impact on the system due to implementing the scheduled change indicated by the scheduled change information based on the acquired history records.

10. An information processing apparatus for managing a system including a plurality of apparatuses classified into a plurality of clusters, the information processing apparatus comprising:
a memory configured to store history records each including content related to a change in configuration information of at least one or more apparatuses amongst apparatuses belonging to one of the clusters; and
a processor configured to perform a procedure including:
acquiring, from the memory, based on scheduled change information indicating a scheduled change in the configuration information of apparatuses accounting for a first rate amongst apparatuses belonging to a particular one of the clusters, one or more history records each associated with a change in the configuration information of apparatuses accounting for a second rate amongst apparatuses belonging to one of the clusters, the second rate satisfying a predetermined similarity relationship with the first rate; and
predicting, based on the acquired history records, an impact on the system due to implementing the scheduled change indicated by the scheduled change information.
